(19) United States
(12) Patent Application Publication
(10) Pub. No.: US 2016/0293984 A1
(43) Pub. Date: Oct. 6, 2016

(54) FUEL REFORMER FOR FUEL CELL SYSTEM AND FUEL CELL SYSTEM WITH THE SAME

(71) Applicant: H&Power, Inc., Daejeon (KR)

(72) Inventors: Woo Jin Kang, Daejeon (KR); In Yong Kang, Daejeon (KR); Byoung Gwan Gwak, Daejeon (KR); Young Gil Choi, Daejeon (KR)

(21) Appl. No.: 14/931,254

(22) Filed: Nov. 3, 2015

(30) Foreign Application Priority Data
Apr. 3, 2015 (KR) 10-2015-0047519

(51) Int. Cl. H01M 8/06; B01J 19/24

(52) U.S. Cl. CPC H01M 8/0618; B01J 19/24; H01M 8/0631; B01J 2219/00103; B01J 2219/24

(57) ABSTRACT

Provided is a fuel reformer for a fuel cell system, which includes an autothermal reforming reactor having an autothermal reforming reaction catalyst and configured to produce a reforming gas with abundant hydrogen by using a hydrocarbon-based fuel, water and air, an ATO reactor configured to produce a high-temperature combustion gas by burning a fuel-containing tail gas discharged from a fuel cell stack, and an ATO heat exchanger configured to increase a temperature of a mixture of water and air supplied to the autothermal reforming reactor, by using the combustion gas produced by the ATO reactor.

### CROSS-REFERENCE TO RELATED APPLICATION

This application claims priority of Korean Patent Application No. 10-2015-0047519, filed on Apr. 3, 2015, in the KIPO (Korean Intellectual Property Office), the disclosure of which is incorporated herein entirely by reference.

### BACKGROUND OF THE INVENTION

1. Field of the Invention

The present disclosure relates to a fuel cell system, and in particular, to a fuel reformer used for a fuel cell system.

2. Description of the Related Art

A fuel cell is a device for generating electricity by using hydrogen and oxygen, and a fuel reformer of a fuel cell system produces a reforming gas with abundant hydrogen by using a hydrogen-containing fuel. The fuel reformer of the fuel cell system allows the hydrogen-containing fuel to react with a reforming catalyst to produce a reforming gas. The fuel reformer may be classified into steam reforming, partial oxidation reforming and autothermal reforming, depending on reforming methods. The steam reformer has good hydrogen generation efficiency, but the steam reformer requires supply of heat due to endothermic reaction and also has a drawback of low response characteristic. The partial oxidation (POX) reformer does not need supply of heat due to exothermic reaction and has rapid response characteristic, but has a drawback of bad hydrogen yield. The autothermal reformer (ATR) may use advantages of both the steam reformer and the partial oxidation reformer and also has advantages of low energy consumption and rapid response.

The autothermal reformer uses a catalyst for forming a fuel gas. A general catalyst has a powder form, which is shaped into spherical, cylindrical or pellet forms depending on reaction conditions and states. In order to make the above shapes, an additive such as a binder should be used. In addition, an existing catalyst has problems of low specific surface area and creation of differential pressure during reaction. To solve these problems, a monolith catalyst is proposed as an alternative, but due to the monolith natures, inside the monolith, reactivity deteriorates due to gas mixing and rapid gas flow. In order to improve the reforming efficiency, a heat exchanger is used to heat the hydrogen-containing fuel to a temperature suitable for reforming reaction, and then the heated hydrogen-containing fuel is supplied as a reforming catalyst.

In addition, the fuel reformer uses a heat exchanger for improving efficiency. As an example of existing heat exchangers for a fuel reformer, Korean patent registration No. 10-1125724 discloses a structure where reforming fuel channels and exhaust gas channels are disposed alternately by laminating a plurality of heat exchange plates.

### SUMMARY OF THE INVENTION

An embodiment of the present disclosure is directed to providing a fuel reformer for a fuel cell system with improved efficiency and a fuel cell system with the same.

In one general aspect of the present disclosure, there is provided a fuel reformer for a fuel cell system, which includes: an autothermal reforming reactor having an autothermal reforming reaction catalyst and configured to produce a reforming gas with abundant hydrogen by using a hydrocarbon-based fuel, water and air; an ATO reactor configured to produce a high-temperature combustion gas by burning a fuel-containing tail gas discharged from a fuel cell stack; and an ATO heat exchanger configured to increase a temperature of a mixture of water and air supplied to the autothermal reforming reactor, by using the combustion gas produced by the ATO reactor, wherein the ATO heat exchanger includes an outer pipe member 110, an inner pipe member 120 accommodated in the outer pipe member and disposed in the same direction as the outer pipe member, a passage pipe member 150 having a winding unit 151 which surrounds the inner pipe member 120 in a spiral form, and a baffle member 140 protruding from an outer circumference of the inner pipe member in a wall form, and wherein a high-temperature fluid passes through a passage formed between the inner circumference of the outer pipe member and an outer circumference of the inner pipe member, and a low-temperature fluid passes through the passage pipe member 150.

The baffle member may extend to have a spiral form along a peripheral direction of the inner pipe member.

The baffle member and the winding unit may have a double spiral structure at least partially.

A plurality of the baffle members may be provided along a length direction of the inner pipe member.

The heat exchanger may further include a resistance plate member 130 coupled to one end of the inner pipe member, and the resistance plate member includes a closing member 131 for closing an open one end of the inner pipe member, and a leg unit 135 extending outwards from the closing member 131 and fixed to the inner circumference of the outer pipe member.

The fuel reformer may further comprise a HDS reactor configured to remove sulfur from the reforming gas discharged from the ATR reactor, and a HTS reactor, a MTS reactor and a PROx reactor disposed in order to reduce a content of carbon monoxide from the reforming gas discharged from the HDS reactor, and additional heat exchangers may be installed between the ATR reactor and the HDS reactor, between the HTS reactor and the MTS reactor, and between the MTS reactor and the PROx reactor, respectively.

The autothermal reforming reaction catalyst may include a monolith catalyst and a support laminated on the monolith catalyst, and the support may be a metal foam, a metal net or a monolith structure.

The support may be laminated on the entire surface of the monolith catalyst.

The monolith catalyst may include a monolith substrate, a buffer layer laminated on the monolith substrate and made of a mixture of at least one kind of first oxide selected from the group consisting of zirconium oxide, cerium oxide, copper oxide and nickel oxide and at least one kind of second oxide selected from the components of the monolith substrate, and a platinum layer laminated on the buffer layer.

In another aspect of the present disclosure, there is provided a fuel cell system, which includes the fuel reformer described as above; and a fuel cell stack configured to produce electricity by receiving a reforming gas supplied from the fuel reformer, wherein a fuel-containing tail gas discharged from the fuel cell stack is supplied to the ATO reactor.

According to the present disclosure, the objects of the present disclosure described above may be entirely accomplished. In detail, a fuel pipe for passing a fuel is wound in a spiral form around a ring-shaped passage through which a combustion gas passes, and a baffle member forming a double spiral structure together with the fuel pipe is formed at the ring-shaped passage, thereby improving heat exchange efficiency at the ring-shaped passage.

In addition, an autothermal reforming reaction catalyst of a fuel cell according to the present disclosure includes a monolith catalyst and a support laminated on the monolith catalyst, and the support is any one of a metal foam, a metal net and a monolith catalyst. In other words, if the monolith catalyst is used solely, high specific surface area and low differential pressure are ensured, but while the fuel is reformed, due to the monolith natures, reactivity may deteriorates due to gas mixing and rapid gas flow. However, in the present disclosure, in order to solve the problem, the support such as a metal foam is separately provided on the monolith catalyst, which decreases mixing and flow rate of the reaction gas in the monolith channel and thus may elongate the time when the catalyst is actually in contact with the reaction gas. Further, the autothermal reformer catalyst of a fuel cell according to the present disclosure has a structure where two layers, namely a composite oxide layer (buffer layer) and a metallic catalyst layer, are laminated on a monolith structure. In particular, since the buffer layer includes the same components as the monolith catalyst, the mechanical durability between the support and the catalyst may be improved. In addition, the monolith structure may give an increased specific surface area, and the micro channel of the monolith catalyst induces gas reaction at a sufficient rate. Therefore, it is possible to prevent any problem of differential pressure caused by pressure drop or irregularity.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a schematic view showing a fuel cell system according to an embodiment of the present disclosure.

FIG. 2 is a vertical sectional view showing an autothermal reforming reaction catalyst employed in an autothermal reforming reactor (ATR) depicted in FIG. 1.

FIG. 3 is a perspective sectional view showing a monolith catalyst depicted in FIG. 2.

FIG. 4 shows an experimental result where an autothermal reforming reaction catalyst prepared according to the present disclosure is experimented with dimethyl ether (DME), and FIG. 5 is an experimental result of a pellet-type catalyst according to a comparative example.

FIG. 6 is a perspective view showing a heat exchanger depicted in FIG. 1.

FIG. 7 is a side view showing the heat exchanger of FIG. 6, where an outer pipe member is cut off to show the inner configuration.

FIG. 8 is a plane view showing the heat exchanger of FIG. 6.

FIG. 9 is a perspective view showing the heat exchanger of FIG. 6, from which an outer pipe member and a resistance plate member are excluded.

FIG. 10 is a perspective view showing the heat exchanger of FIG. 9, from which a connection tube is excluded.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

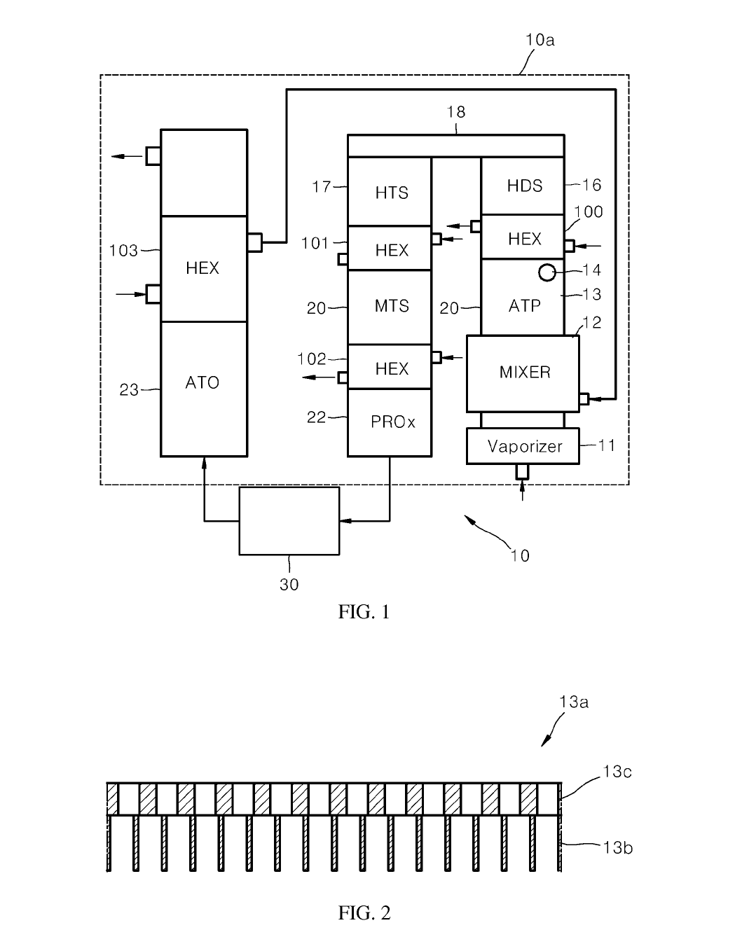

FIG. 1 is a schematic view showing a fuel cell system according to an embodiment of the present disclosure. Referring to FIG. 1, a fuel cell system 10 according to an embodiment of the present disclosure includes a fuel reformer 10a, and a fuel cell stack 30 for producing electricity by using a reforming gas supplied from the fuel reformer 10a.

The fuel reformer 10a includes a fuel vaporizer 11, a mixer 12, an autothermal reforming reactor 13, an igniter 14, a first heat exchanger 100, a HDS reactor 16, a HTS reactor 17, a connection tube 18, a second heat exchanger 101, a MTS reactor 20, a heat exchanger 102, a PROx reactor 22, an ATO reactor 23, and a fourth heat exchanger 103. The fuel reformer 10a performs an autothermal reforming reaction with a hydrocarbon-based fuel to produce hydrogen supplied to the fuel cell stack 30.

The fuel vaporizer 11 evaporates a hydrocarbon-based fuel such as gasoline or diesel, supplied from a fuel tank. The fuel vaporizer 11 may employ any kind of vaporizer commonly used in the art, and thus this is not described in detail here. The fuel evaporated by the fuel vaporizer 11 is supplied to the mixer 12.

The mixer 12 evenly mix the evaporated fuel supplied from the fuel vaporizer 11 with steam and air heated while passing through a fifth heat exchanger 24. The evaporated fuel, the steam and the air mixed at the mixer 12 are supplied to the autothermal reforming reactor 13.

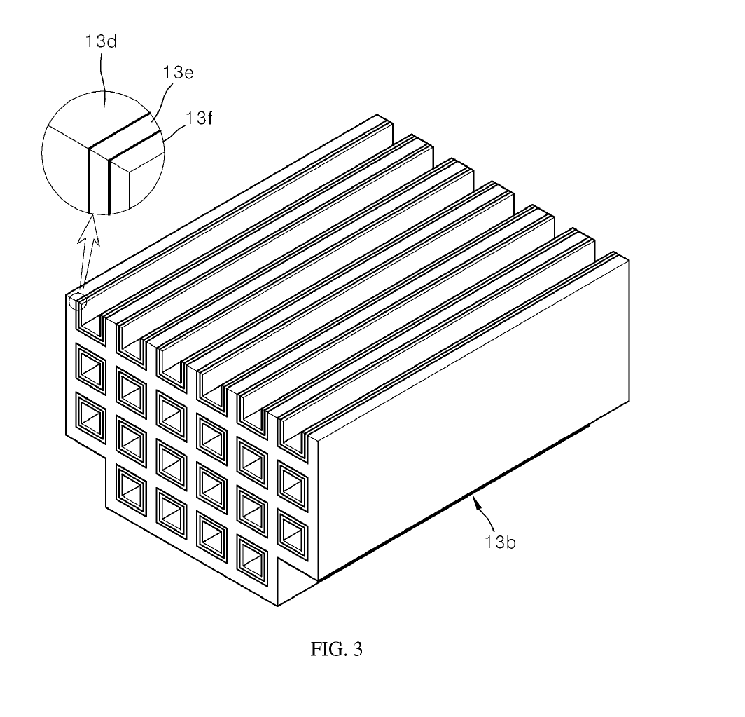

The autothermal reforming reactor 13 generates a reforming gas with abundant hydrogen from the mixture of the evaporated fuel, the steam and the air supplied from the mixer 12 by means of an autothermal reforming reaction. For the autothermal reforming reaction, the autothermal reforming reactor 13 includes an autothermal reforming reaction catalyst. FIG. 2 is a vertical sectional view showing an autothermal reforming reaction catalyst 13a used at the autothermal reforming reactor 13. Referring to FIG. 2, the autothermal reforming reaction catalyst 13a includes a monolith catalyst 13b and a support 13c provided on the monolith catalyst 13b. The support 13c is located at an upstream of the monolith catalyst 13b. The support 13c has a channel through which the catalyst may be mixed while moving a sufficiently long distance. For example, the support 13c may be a metal foam, a metal net or another monolith structure. The support 13c having a metal net form enhances gas mixing to help an actual catalyst to react with a gas of an ideal mixture composition. In other words, in the present disclosure, when a reaction gas flows into the monolith catalyst 13b at a high speed, in order to prevent the reaction gas from being insufficiently mixed due to the high speed, a channel which the introduced reaction gas contacts and moves through is formed in advance prior to the monolith catalyst 13b. As a result, a bad reactivity problem caused by gas mixing in the monolith is solved. Therefore, the support 13c according to the present disclosure may be regarded as a kind of resisting layer for enhancing catalyst efficiency for better mixing of the reaction gas. In an embodiment of the present disclosure, a mesh produced by Inconel (Inconel mesh) is used as the support 13c, but besides it, a metal foam or a monolith structure through which gas may move in a certain direction may also be used.

The support 13c according to an embodiment of the present disclosure is laminated on all area (the entire area) of the monolith catalyst 13b, and by doing so, the reacting time between the monolith catalyst and the gas may be uniformly increased. Further, in an embodiment of the present disclosure, the support 13c is an Inconel mesh.

In another embodiment of the present disclosure, in case of a monolith catalyst, a metallic catalyst layer should be coated to a relatively small channel, but in an existing technique, it is difficult to ensure a sufficient adhesion force between the monolith catalyst and the metallic catalyst layer. Therefore, in the present disclosure, in order to maximize technical effects of the monolith catalyst, an autothermal reforming reaction catalyst structure of a fuel cell as shown in FIG. 3 is provided. Referring to FIG. 3, the monolith catalyst 13b includes a monolith substrate 13d, a buffer layer 13e laminated on the monolith substrate 13d, and a metallic catalyst layer 13f laminated on the buffer layer 13e. In an embodiment of the present disclosure, the monolith substrate 13d includes magnesium silicate-aluminum composite material.

The buffer layer 13e is coated onto the monolith substrate 13d. In an embodiment of the present disclosure, the buffer layer 13e includes at least one kind of first oxide selected from the group consisting of zirconium oxide, cerium oxide, copper oxide and nickel oxide and at least one kind of second oxide selected from the components of the monolith substrate. In an embodiment of the present disclosure, the first oxide is a cerium oxide, and the second oxide is alumina. Here, a weight ratio between the first oxide and the second oxide may be 2:8 to 4:6. By doing so, it is possible to induce sufficient adhesion between the monolith substrate 13d and the metallic catalyst layer 13f.

In other words, in an embodiment of the present disclosure, the first oxide of the buffer layer 13e gives a sufficient adhesion force with the metallic catalyst layer 13f when the metallic catalyst layer 13f is thermally treated after being coated with slurry. In addition, the second oxide may be any one of components of the monolith substrate 13d, for example an oxide including aluminum (alumina), and the second oxide may allow the buffer layer 13e to be sufficiently adhered to the monolith substrate 13d during a thermal treatment process performed after coating slurry of the buffer layer 13e is coated onto the monolith substrate 13d.

In an embodiment of the present disclosure, the metallic catalyst layer 13f is laminated on the buffer layer 13e, and the metallic catalyst layer 13f, for example a platinum layer, is sufficiently adhered to the monolith substrate 13d by means of the buffer layer 13e.

Regarding an autothermal reforming reaction catalyst of a fuel cell according to another embodiment of the present disclosure, slurry is applied onto a monolith substrate to coat each layer, and the slurry applied in each stage is thermally treated. Hereinafter, a method for manufacturing a monolith catalyst according to an embodiment of the present disclosure will be described.

### EXAMPLE

### Preparation of Buffer Layer Coating Slurry

Acetone and methanol were mixed at a weight ratio of 1:2, a terpineol-based or glycerol-based additive was mixed thereto, and a mixture of cerium oxide and aluminum oxide mixed at a weight ratio of 3:7 was added thereto to prepare buffer layer coating slurry.

### Coating and Thermal Treatment of the Buffer Layer Coating Slurry

After that, a ceramic monolith carrier was immersed in the buffer layer coating slurry for coating, then dried in a drying furnace at 250 C for 2 hours and calcined in an electric furnace at 1150 C for 4 hours to coat the buffer layer onto a monolith-type support.

### Preparation of Metallic Catalyst Layer Coating Slurry

After that, a terpineol-based or glycerol-based additive was mixed with a mixture solution of xylene and methanol (weight ratio=2:1), and 0.5 to 5 weight % of platinum was also added thereto on the basis of the entire weight to prepare catalyst coating slurry.

### Coating and Thermal Treatment of the Metallic Catalyst Layer Coating Slurry

After that, the ceramic monolith carrier coated with the buffer layer was immersed in the catalyst coating slurry for coating, dried in a drying furnace at 250° C. for 2 hours and calcined in an electric furnace at 900° C. for 4 hours to laminate the metallic catalyst layer. In particular, the thermal treatment temperature of the metallic catalyst layer coating slurry is lower than the thermal treatment temperature of the buffer layer coating slurry, in order to prevent the multi-layered structure from being damaged due to excessively high temperature.

### Experimental example

Catalyst effects of the autothermal reforming reaction catalyst of the present disclosure prepared as above were analyzed in comparison with an existing pellet-type catalyst.

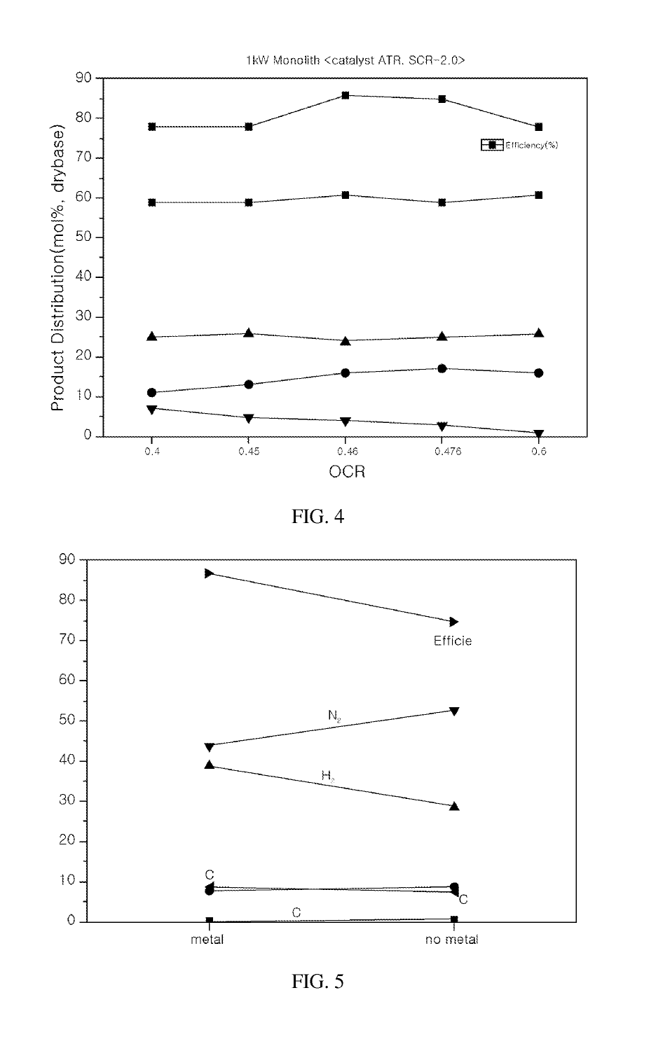

FIG. 4 shows an experimental result where an autothermal reforming reaction catalyst prepared according to the present disclosure is experimented with dimethyl ether (DME), and FIG. 5 is an experimental result of a pellet-type catalyst according to a comparative example.

Referring to FIGS. 4 and 5, it can be found that if the autothermal reforming catalyst according to the present disclosure is used, the amount of used platinum catalyst may be greatly reduced in comparison to an existing manufacturing method even though the efficiency and endurance are maintained in a level similar to that of an existing pellet-type catalyst.

The igniter 14 is installed at the autothermal reforming reactor 13 and used for starting the autothermal reforming reactor 13. In other words, in an early stage, the evaporated fuel and the air are supplied to autothermal reforming reactor 13, and the igniter 14 operates to start combustion. If the autothermal reforming reactor 13 reaches a predetermined temperature due to the combustion, the steam is supplied, and it is checked whether reactions occur normally. In the autothermal reforming reactor 13, conditions for normal reaction include 700° C. or above of outlet temperature, 30% or above of hydrogen, and about 10% of carbon monoxide.

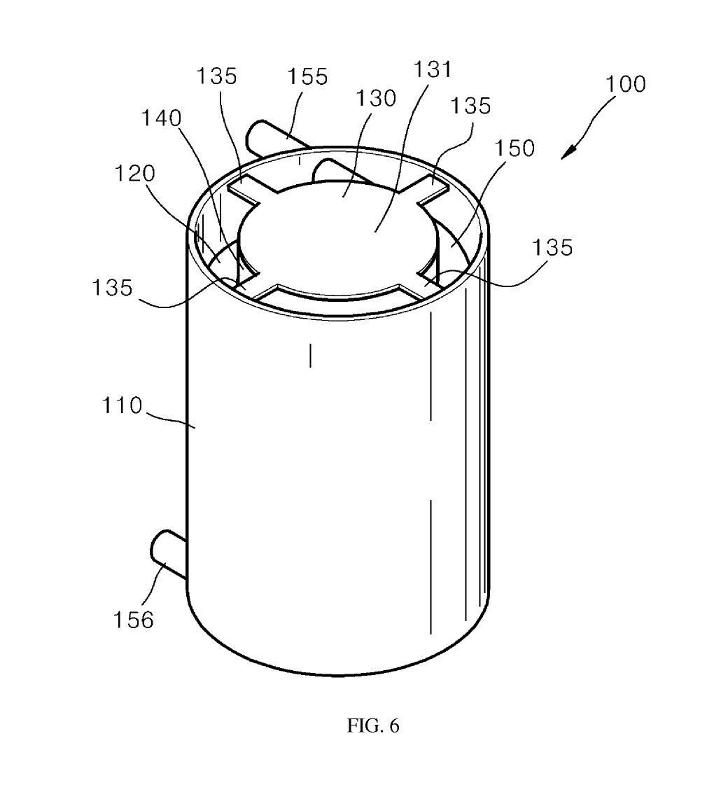

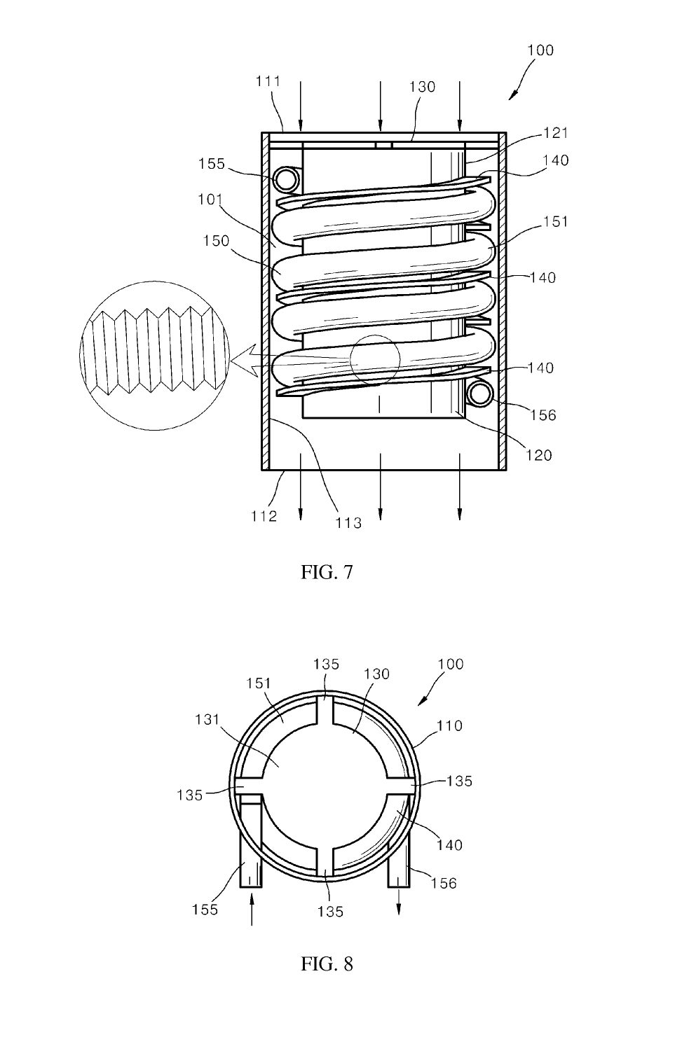

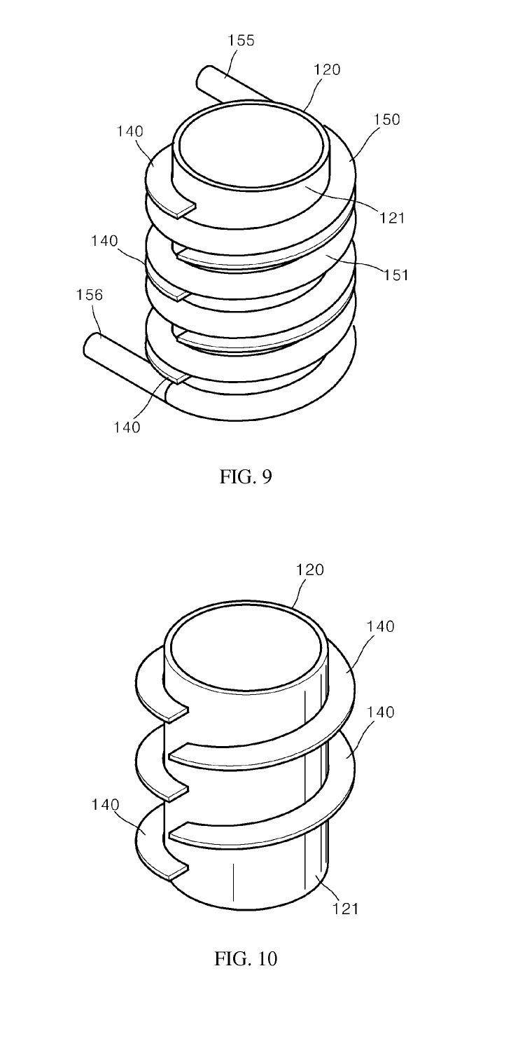

The first heat exchanger 100 cools a high-temperature (about 70° C. or above) products generated by the autothermal reforming reactor 13 to a temperature suitable for an inlet condition of the HTS reactor 16 by means of heat exchange with low-temperature water. FIGS. 6 to 10 are diagrams showing the first heat exchanger 100. Referring to FIGS. 6 and 7, the first heat exchanger 100 includes an outer pipe member 110, an inner pipe member 120 located in the outer pipe member 110, a resistance plate member 130 coupled to a front end (or, an upstream end) of the inner pipe member 120, a plurality of baffle members 140 formed at an outer surface of the inner pipe member 120, and a passage pipe member 150 formed in a space between the outer pipe member 110 and the inner pipe member 120. A high-temperature gas passing through a space formed between the outer pipe member 110 and the inner pipe member 120 and a low-temperature water passing through the passage pipe member 150 exchange heat, so that the high-temperature gas is cooled to a temperature (above 330° C. or below) suitable for the HTS reactor, and the low-temperature water is heated.

Referring to FIGS. 6 and 7, the outer pipe member 110 has an approximately circular pipe shape and has a space therein where the inner pipe member 120 is accommodated. Both ends (an upper end and a lower end in the figure) of the outer pipe member 110 are opened. A first end (the upper end in the figure) of both ends serves as an inlet 111 through which a high-temperature gas flows in, and a second end (the lower end in the figure) serves as an outlet 112 through which the high-temperature gas introduced through the first end is discharged. The inner circumference 113 of the outer pipe member 110 is spaced apart from the inner pipe member 120 by a predetermined distance.

Referring to FIGS. 6, 7, 9 and 10, the inner pipe member 120 has an approximately circular pipe shape and has a smaller size than the outer pipe member 110 to be accommodated in the outer pipe member 110. The inner pipe member 120 is disposed coaxially with the outer pipe member 110, and a ring-shaped passage 101 is formed between the outer circumference 121 of the inner pipe member 120 and the inner circumference 113 of the outer pipe member 110. The high-temperature gas introduced through the inlet 111 passes through the ring-shaped passage 101 and exchanges heat with water which passes through the passage pipe member 150, so as to be cooled, and the cooled gas is discharged through the outlet 112. Between both opened ends, an end (the upper end in the figure) of the inner pipe member 120 toward the inlet 111 is closed by the resistance plate member 130.

Referring to FIGS. 6 to 10, the resistance plate member 130 is a member with a flat plate shape and is coupled to an end (the upper end in the figure) of the inner pipe member 120 integrally. The resistance plate member 130 includes a closing member 131 and a plurality of leg units 135 extending from the closing member 131. The closing member 131 has a circular shape with the same diameter as the outer diameter of the inner pipe member 120. The closing member 131 closes the opened upper end of the inner pipe member 120 and is substantially perpendicular to the flowing direction of the high-temperature gas introduced through the inlet 111. The high-temperature gas introduced through the inlet 111 collides with the closing member 131 to form turbulent flow and enters the ring-shaped passage 101 to improve heat exchange efficiency. The plurality of leg units 135 radially extend outwards from the closing member 131. In this embodiment, four leg units 135 are located at regular intervals, but the present disclosure is not limited thereto. Ends of the plurality of leg units 135 are fixed to the inner circumference 113 of the outer pipe member 110, respectively. Accordingly, the inner pipe member 120 fixed to the resistance plate member 130 is also fixed to the outer pipe member 110. The plurality of leg units 135 may also form turbulence at the introduced fuel and thus contributes to the improvement of heat exchange efficiency.

The plurality of baffle members 140 have a wall shape protruding outwards from the outer circumference 121 of the inner pipe member 120. In this embodiment, three baffle members 140 are disposed in order along the length direction of the inner pipe member 120 (namely, the advancing direction of the ring-shaped passage 101). The number of the baffle members 140 may be suitably changed, and the changed number of baffle members 140 also falls within the scope of the present disclosure. An outer end of the baffle member 140 is spaced apart from the inner circumference 113 of the outer pipe member 110. The baffle member 140 extends along a circumferential direction of the inner pipe member 120 in a spiral form with a pitch P greater than the diameter of the passage pipe member 150. The baffle member 140 extends approximately a turn (namely, 360 degrees) along the circumferential direction of the inner pipe member 120. The same pitch is provided to two baffle members 140 adjacent to each other. The baffle member 140 improves heat exchange efficiency at the ring-shaped passage 101.

The passage pipe member 150 includes a winding unit 151 surrounding the inner pipe member 120 at the ring-shaped passage 101, and two extensions 155, 156 respectively coupled to both ends of the winding unit 151 in a length direction. The low-temperature water passes through the passage pipe member 150.

The winding unit 151 spirally surrounds the inner pipe member 120 at the ring-shaped passage 101. The winding unit 151 and the baffle member 140 form a double spiral structure. In this embodiment, the winding unit 151 is a corrugated pipe ensuring high heat exchange efficiency and easy winding.

Two extensions 155, 156 include a first extension 155 through which water flows in and a second extension 156 through which water flows out.

The first extension 155 extends from the first end of the winding unit 151 and is fixed to the outer pipe member 110 while passing through the outer pipe member 110. Water flows in through the first extension 155.

The second extension 156 extends from the second end of the winding unit 151 and is fixed to the outer pipe member 110 while passing through the outer pipe member 110. Heated water flows out through the second extension 156.

Now, operations of the heat exchanger according to an embodiment of the present disclosure will be described in detail on the basis of the above configuration.

The low-temperature water flows in through the first extension 155, and the water introduced through the first extension 155 passes through the winding unit 151 extending in a spiral form around the ring-shaped passage 101 and flows out through the second extension 156. The high-temperature gas supplied to the autothermal reforming reactor 13 flows in through the inlet 111 formed at the opened upper end of the outer pipe member 110, is cooled by means of heat exchange while passing through the ring-shaped passage 101, and flows out through the outlet 112 formed at the opened lower end of the outer pipe member 110. The high-temperature gas and the low-temperature water exchange heat at the ring-shaped passage 101 in which the high-temperature gas flows and around which the winding unit 151 is provided, so that the gas is cooled and the water is heated. The plurality of baffle members 140 forming a double spiral structure together with the winding unit 151 improves heat exchange efficiency, and the resistance plate member 130 located at the front end to induce turbulence of the combustion gas also improves heat exchange efficiency. The cooled reforming gas is supplied to the HDS reactor 16, and the heated water is supplied to the fourth heat exchanger 103.

Referring to FIG. 1, the HDS (hydrodesulfurization) reactor 16 is a desulfurizer and removes sulfur from the gas supplied from the autothermal reforming reactor 13 and the first heat exchanger 14. The HDS reactor maintains its temperature at about 330 C or below. The gas discharged from the HDS reactor 16 is supplied to the HTS reactor 17 through the connection tube 18.

The HTS (high temperature water gas shift) reactor 17 converts carbon monoxide generated by the autothermal reforming reaction into hydrogen and carbon dioxide. Since the carbon monoxide deteriorates performance of a fuel cell, in the reforming gas, the amount of carbon monoxide should be reduced to the minimum. The HTS reactor may adopt a commonly used HTS reactor and thus is not described in detail here. The HTS reactor maintains its temperature at about 300° C. or below.

The connection tube 18 connects the HDS reactor 16 to the HTS reactor 17. The reforming gas discharged to the HDS reactor 16 is naturally cooled while passing through the connection tube 18 and is supplied to the HTS reactor 17.

The second heat exchanger 101 cools the high-temperature gas (about 300° C.) discharged from the HTS reactor 17 to a temperature suitable for the reaction condition of the MTS reactor 20 by means of heat exchange with the low-temperature water. Configuration and operations of the second heat exchanger 101 are identical to those of the first heat exchanger 100 described above and thus are not described in detail here. The water passing through the second heat exchanger 101 is supplied with an increased temperature to the fourth heat exchanger 103.

The MTS (middle temperature water gas shift) reactor 20 further lowers the content of carbon monoxide in the reforming gas supplied through the second heat exchanger 101. The MTS reactor 20 employs a commonly used MTS reactor and thus is not described in detail here. The MTS reactor 20 maintains its temperature at about 270° C. or below.

The third heat exchanger 102 cools the high-temperature gas (about 270° C.) discharged from the MTS reactor 20 to a temperature suitable for the reaction condition with the PROx reactor 22 by means of heat exchange with the low-temperature water. Configuration and operations of the third heat exchanger 102 are identical to those of the first heat exchanger 100 described above and thus are not described in detail here. The water passing through the third heat exchanger 102 is supplied with an increased temperature to the fourth heat exchanger 103.

The PROx (preferential oxidation) reactor 22 further lowers the content of carbon monoxide in the reforming gas supplied through the third heat exchanger 102. The PROx reactor 22 employs a commonly used PROx reactor and thus is not described in detail here. The PROx reactor 22 maintains its temperature at about 190° C. or below. The reforming gas discharged from the PROx reactor 22 is supplied to the fuel cell stack 30.

The ATO reactor 23 generates a high-temperature combustion gas by using a tail gas containing hydrogen discharged from the fuel cell stack 30. The ATO reactor 23 employs a commonly used ATO reactor and thus is not described in detail here. Though not shown in the figures, a mixer for mixing the tail gas with an external gas and supplying the mixed gas to the ATO reactor 23 is provided at the front end of the ATO reactor 23. The high-temperature gas generated by the ATO reactor 23 passes through the fourth heat exchanger 103 and is then discharged out.

The fourth heat exchanger 103 heats a mixture of an external air and water heated through the first, second and third heat exchangers 100, 101, 102 by using the high-temperature combustion gas generated by the ATO reactor 23. The mixture of water and air heated by the fourth heat exchanger 103 is supplied to the mixer 12 and mixed with a fuel.

The fuel cell stack 30 produces electricity by using hydrogen and oxygen. For this, a fuel supplied from the fuel reformer 10a and an external air containing oxygen are supplied to the fuel cell stack 30. Among the fuel supplied to the fuel cell stack 30, a fuel (tail gas) not reacting but discharged from the fuel cell stack 30 is supplied to the ATO reactor 23 and burned.

Through not shown in the figures, the fuel cell system 10 further includes components for suitably supplying water and air.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A fuel reformer for a fuel cell system comprising:
an autothermal reforming reactor having an autothermal reforming reaction catalyst and configured to produce a reforming gas with abundant hydrogen by using a hydrocarbon-based fuel, water and air;
an ATO reactor configured to produce a high-temperature combustion gas by burning a fuel-containing tail gas discharged from a fuel cell stack; and
an ATO heat exchanger configured to increase a temperature of a mixture of water and air supplied to the autothermal reforming reactor, by using the combustion gas produced by the ATO reactor,
wherein the ATO heat exchanger comprises:
an outer pipe member;
an inner pipe member accommodated in the outer pipe member and disposed in the same direction as the outer pipe member;
a passage pipe member having a winding unit which surrounds the inner pipe member in a spiral form; and
a baffle member protruding from an outer circumference of the inner pipe member in a wall form,
wherein a high-temperature fluid passes through a passage formed between the inner circumference of the outer pipe member and an outer circumference of the inner pipe member, and a low-temperature fluid passes through the passage pipe member.

2. The fuel reformer for a fuel cell system of claim 1, wherein the baffle member extends to have a spiral form along a peripheral direction of the inner pipe member.

3. The fuel reformer for a fuel cell system of claim 2, wherein the baffle member and the winding unit have a double spiral structure at least partially.

4. The fuel reformer for a fuel cell system of claim 2, wherein a plurality of the baffle members is provided along a length direction of the inner pipe member.

5. The fuel reformer for a fuel cell system of claim 1, wherein the heat exchanger further includes a resistance plate member coupled to one end of the inner pipe member, and the resistance plate member includes a closing member for closing an open one end of the inner pipe member, and a leg unit extending outwards from the closing member and fixed to the inner circumference of the outer pipe member.

6. The fuel reformer for a fuel cell system of claim 1, wherein the fuel reformer further comprises a HDS reactor configured to remove sulfur from the reforming gas discharged from the ATR reactor, and a HTS reactor, a MTS reactor and a PROx reactor disposed in order to reduce a content of carbon monoxide from the reforming gas discharged from the HDS reactor.

7. The fuel reformer for a fuel cell system of claim 6, wherein additional heat exchangers are installed between the ATR reactor and the HDS reactor, between the HTS reactor and the MTS reactor, and between the MTS reactor and the PROx reactor, respectively.

8. The fuel reformer for a fuel cell system of claim 1, wherein the autothermal reforming reaction catalyst includes a monolith catalyst and a support laminated on the monolith catalyst, and the support is a metal foam, a metal net or a monolith structure.

9. The fuel reformer for a fuel cell system of claim 8, wherein the support is laminated on the entire surface of the monolith catalyst.

10. The fuel reformer for a fuel cell system of claim 8, wherein the monolith catalyst includes a monolith substrate, a buffer layer laminated on the monolith substrate and made of a mixture of at least one kind of first oxide selected from the group consisting of zirconium oxide, cerium oxide, copper oxide and nickel oxide and at least one kind of second oxide selected from the components of the monolith substrate, and a platinum layer laminated on the buffer layer.

11. A fuel cell system comprising:
A fuel reformer comprises:
an autothermal reforming reactor having an autothermal reforming reaction catalyst and configured to produce a reforming gas with abundant hydrogen by using a hydrocarbon-based fuel, water and air;
an ATO reactor configured to produce a high-temperature combustion gas by burning a fuel-containing tail gas discharged from a fuel cell stack; and
an ATO heat exchanger configured to increase a temperature of a mixture of water and air supplied to the autothermal reforming reactor, by using the combustion gas produced by the ATO reactor,
wherein the ATO heat exchanger comprises:
an outer pipe member;
an inner pipe member accommodated in the outer pipe member and disposed in the same direction as the outer pipe member;
a passage pipe member having a winding unit which surrounds the inner pipe member in a spiral form; and
a baffle member protruding from an outer circumference of the inner pipe member in a wall form,
wherein a high-temperature fluid passes through a passage formed between the inner circumference of the outer pipe member and an outer circumference of the inner pipe member, and a low-temperature fluid passes through the passage pipe member, and
a fuel cell stack configured to produce electricity by receiving a reforming gas supplied from the fuel reformer,
wherein a fuel-containing tail gas discharged from the fuel cell stack is supplied to the ATO reactor.

12. The fuel cell system of claim 11, wherein the baffle member extends to have a spiral form along a peripheral direction of the inner pipe member.

13. The fuel cell system of claim 12, wherein the baffle member and the winding unit have a double spiral structure at least partially.

14. The fuel cell system of claim 12, wherein a plurality of the baffle members is provided along a length direction of the inner pipe member.

15. The fuel cell system of claim 11, wherein the heat exchanger further includes a resistance plate member coupled to one end of the inner pipe member, and the resistance plate member includes a closing member for closing an open one end of the inner pipe member, and a leg unit extending outwards from the closing member and fixed to the inner circumference of the outer pipe member.

16. The fuel system of claim 11, wherein the fuel reformer further comprises a HDS reactor configured to remove sulfur from the reforming gas discharged from the ATR reactor, and a HTS reactor, a MTS reactor and a PROx reactor disposed in order to reduce a content of carbon monoxide from the reforming gas discharged from the HDS reactor.

17. The fuel cell system claim 16, wherein additional heat exchangers are installed between the ATR reactor and the HDS reactor, between the HTS reactor and the MTS reactor, and between the MTS reactor and the PROx reactor, respectively.

18. The fuel cell system of claim 11, wherein the autothermal reforming reaction catalyst includes a monolith catalyst and a support laminated on the monolith catalyst, and the support is a metal foam, a metal net or a monolith structure.

19. The fuel cell system of claim 18, wherein the support is laminated on the entire surface of the monolith catalyst.

20. The fuel cell system of claim 18, wherein the monolith catalyst includes a monolith substrate, a buffer layer laminated on the monolith substrate and made of a mixture of at least one kind of first oxide selected from the group consisting of zirconium oxide, cerium oxide, copper oxide and nickel oxide and at least one kind of second oxide selected from the components of the monolith substrate, and a platinum layer laminated on the buffer layer.
